(19) United States
(12) Patent Application Publication
(10) Pub. No.: US 2008/0304418 A1
(43) Pub. Date: Dec. 11, 2008

(54) MAINTENANCE SYSTEM FOR A SET OF EQUIPMENT

(75) Inventors: Francois FOURNIER, Roques Sur Garonne (FR); Christian SANNINO, Muret (FR); Carine BAILLY, Tournefeuille (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/131,568

(22) Filed: Jun. 26, 2008

(30) Foreign Application Priority Data
Jun. 5, 2007 (FR) 07 04012

(51) Int. Cl. G06F 11/00

(52) U.S. Cl. 370/242

(57) ABSTRACT

The invention relates to a maintenance system for a set of equipment of an aircraft, forming a physical network (106) configured by configuration files (101). The maintenance system according to the invention comprises a model M (104) of the set of equipment of the physical network, taking into account the topology of the physical network and the interactions between the various equipment items. This model M is constructed and updated in real time from data (including, for example, the configuration tables) concerning the physical network and the equipment items themselves.

### RELATED APPLICATIONS

The present application is based on, and claims priority from, French Application Number 07 04012, filed Jun. 5, 2007, the disclosure of which is hereby incorporated by reference herein in its entirety.

### TECHNICAL FIELD

The invention relates to the maintenance of a set of equipment, such as a set of equipment of an aircraft fulfilling various functions essential to the completion of a flight.

### BACKGROUND OF THE INVENTION

Such equipment intercommunicates and communicates externally via a physical network. This communication network associated with a set of equipment is known by the acronym ADCN, standing for “Airborne Data Communication Network”.

Each item of equipment communicating over the physical network comprises at least one connector. The connector is a physical component directly linked to the network. There are two kinds of connectors: the sending-mode connectors (for sending data over the network) and the receiving-mode connectors (for acquiring data circulate on the network). Some equipment items, called switches, are dedicated to the distribution of the information over the physical network. The switches have sending and receiving-mode connectors. A link between a sending-mode connector of a first equipment item and a receiving-mode connector of a second equipment item is called a link. Each equipment item of the physical network is identified notably by: a name, a serial number, a version number and a supplier name.

The physical network is open-ended, and various events can modify its topology: the loading of new equipment into the network, network equipment failures, the reconfiguration of the network or selective passivation (that is, no longer using a part of the equipment network).

Moreover, the data flows circulating over the physical network are represented by a logical network. FIG. 1 gives an example of logical network representing the interactions between two equipment items linked by a link. The logical network comprises a first object 201 representing a first equipment item A. A second object 202 represents a sending-mode connector Cₒᵤₜ of the equipment item A. A third object 203 represents a receiving-mode connector Cᵢₙ of the equipment item A. A fourth object 204 represents a second equipment item B. A fifth object 205 represents a sending-mode connector Cₒᵤₜ of the equipment item B. A sixth object 206 represents a receiving-mode connector Cᵢₙ of the equipment item B. A seventh object 207 represents the link between the two equipment items.

To improve the degree of trust given to these equipment items and to handle their maintenance, more often than not, each of them has its operation monitored, which involves providing them with internal “monitoring” mechanisms, hardware and/or software, for detecting anomalies.

The main function of these monitoring mechanisms is to ensure flight safety by frequently testing the availability of the equipment, that is, the normality of its behavior, and the auxiliary function is to provide an aid to maintenance facilitating fault tracing on the equipment.

In its main flight safety function, a monitoring mechanism is responsible for issuing alarms intended for the pilot to warn of a possible abrupt unavailability of the equipment being monitored.

In its auxiliary maintenance aid function, a function known by the acronym “BITE”, standing for “Built In Test Equipment”, the monitoring mechanism is responsible for providing, whenever it generates a non-availability alarm in execution of its main flight safety function, a more or less detailed operating status report intended to complement a post-flight report, PFR or last leg report, LLR, intended for the ground maintenance personnel.

The operation report generated by a maintenance aid BITE function is stored on the equipment concerned in the form of BITE data snapshots and can be viewed by the ground maintenance personnel by means of a keyboard-screen interface, such as the MCDU (Multipurpose Control Display Unit) by which the crew of an aircraft dialogs with the aircraft's various equipment items or a dedicated console connected to the airplane data transmission bus.

To reduce the downtime of an aircraft, its equipment, whether mechanical such as valves, pumps, etc., electrical such as switches, relays, batteries, etc., or electronic such as automatic pilot, navigation and other computers, is, as often as possible, designed so as to be able to be easily removed and rapidly replaced by standard exchange. Such equipment is designated LRU, standing for “Line Replaceable Unit”.

The concept of parts that are easy to remove and replace by standard exchange is even extended to a lower level of assembly, to within the equipment itself, by the use of modular architectures, with modules that can easily be removed and replaced by standard exchange, some possibly being multifunction modules, that is, modules that can be used in multiple different equipment items or that support several functions in time share mode. Such modules are designated LRM, standing for “Line Replaceable Modules”.

A monitoring BITE function can exist at each of the two possible levels of standard part exchange within an aircraft: equipment level LRU and module level LRM. It is called resource BITE function when it concerns a hardware composition or the first level software used (operating system, drivers, etc.) and application BITE function when it concerns higher level software. It is handled by electronics of which a more or less significant hardware part follows what happens to the monitored part.

A monitoring BITE function can also exist at a third level of assembly combining several LRM modules placed within one and the same cabinet or rack. It is then called global BITE function and consists of a prediagnostic facilitating that of the central maintenance computer.

Depending on the degree of equipment of an aircraft, the operation report generated by a maintenance aid BITE function can also be sent to a central maintenance computer (CMC) or centralized fault display interface unit (CFDIU). This central maintenance computer correlates the operation reports obtained from the BITE functions of the various equipment items of the aircraft, between themselves and with equipment non-availability alarms after they have been processed by the FWC computer to derive from them a general post-flight report PFR or LLR at the level of the set of equipment of the aircraft being monitored by monitoring mechanisms. This post-flight report PFR or LLR contains a log of the non-availability alarm messages issued by the various equipment items of the aircraft provided with monitoring mechanisms and alarms presented to the crew, as well as a summary of the non-availability messages produced as a last resort and, more generally, all the information on the operating states of the equipment items that might facilitate the work of the ground maintenance crew, whether this information results from an automatic analysis of the equipment failure messages or notes from the crew.

A maintenance system according to the prior art is described in the American patent U.S. Pat. No. 6,208,955. Such a system comprises a failure tree modeling all the failures and combinations of potential failures of the system and their causes by means of logic equations. Such a failure tree is obtained after an analysis called FTA, standing for “Fault Tree Analysis”. The drawback of such a system is that it requires a new FTA to be produced each time the physical network of the aircraft is modified. In practice, the onboard model in the aircraft is generated on the ground from a first modeling of the physical network. It is static and cannot evolve during the flight to be adapted to a change or a failure that could not have been anticipated on the ground in the FTA. This type of approach can pose problems of comprehensiveness in cases of multiple simultaneous failures.

### SUMMARY OF THE INVENTION

The invention aims to overcome the abovementioned problems by proposing a system handling the maintenance of the physical network and of the set of equipment items comprising a model M, the set of the equipment items of the physical network, taking into account the topology of the physical network and the interactions between the various equipment items and updated in real time. The set of these interactions forms a logical network. This model M is constructed and updated from data (including, for example, configuration tables) concerning the physical and logical networks and the equipment items themselves. The system according to the invention is distinguished from the prior art in that it is based on a model of the physical and logical networks, and not on a fault tree requiring complex analysis in the modeling phase. A first advantage of the system according to the invention is that it produces simple and reliable diagnosis by analyzing the model M to trace the faults, including multiple faults, and create a relationship between the location of the fault and the operational impact of the latter on the set of equipment.

A second advantage of the system according to the invention is that it is possible to use more generic diagnostic algorithms that are also independent of the physical and logical networks, based on the model M. These diagnostic algorithms are also more robust regarding modifications of the physical network.

A third advantage of the system according to the invention is that it can be applied to different maintenance levels and use the BITE functions of an equipment item, of a module or of a set of modules.

Another advantage, linked to the use of a model of the physical and logical networks, is to be able to apply the diagnostic algorithms to network equipment that is not accessible, such as cables.

To this end, the subject of the invention is a maintenance system for a set of equipment of an aircraft, forming a physical network and a logical network configured by configuration files, each item of said equipment being associated with a status indicating whether said equipment is malfunctioning and with data deriving from dependability analyses, each item of said equipment comprising at least one sending-mode connector or one receiving-mode connector. Said maintenance system according to the invention is noteworthy in that it also comprises:
a library of objects representing the equipment of the physical network and the elements of the logical network,
means for creating a model M from configuration files and from the object library,
a model M of the physical and logical networks, comprising the operating state of the equipment of the physical network, of the elements of the logical network and also the data obtained from dependability analyses,
means for signaling modifications of the physical network to the model M in real time,
means for interrogating the physical network regarding the state of said equipment and updating the model M in real time,
diagnostic means using the model M to determine which equipment is malfunctioning.

According to a variant of the invention, the modifications of the physical network comprise: the loading of new equipment into the network, network equipment failures, reconfiguration of the logical network and selective passivation.

According to a variant of the invention, the model M comprises objects representing the equipment, the links and the connectors of the equipment of the physical network and the interactions between equipment.

According to a variant of the invention, the model M also comprises a representation of the logical network, called virtual link, of the data interchanges between a sending item of equipment and receiving equipment, said virtual links being defined by the sending-mode connector of the equipment sending data, by the receiving-mode connectors of the equipment receiving data and by the ordered set of the links used by the data to travel from the sending-mode connector to a receiving-mode connector.

According to a variant of the invention, the objects of the model M include a failure probability established from data obtained from dependability analysis.

According to a variant of the invention, the generic diagnostic means comprise a fault tracing algorithm determining the or each item of equipment most probably failing from the correlation of the fault states of the equipment and the equipment failure probabilities.

According to a variant of the invention, the generic diagnostic means also comprise the identification of the equipment that cannot be accessed: connected to one or more equipment items that are malfunctioning or that have a defective sending-mode connector.

According to a variant of the invention, when an alarm signals a malfunction, the generic diagnostic means establish a relationship between said malfunction and a fault located by the fault tracing algorithm.

According to a variant of the invention, the generic diagnostic means also comprise the filtering of the equipment currently being reinitialized or switched off.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, already described, represents an exemplary logical network, according to prior art.

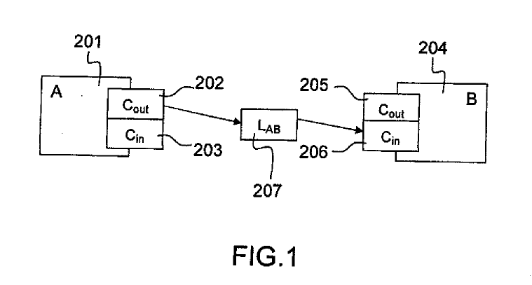

FIG. 2 represents an exemplary architecture of the maintenance system according to the invention.

### DETAILED DESCRIPTION OF THE INVENTION

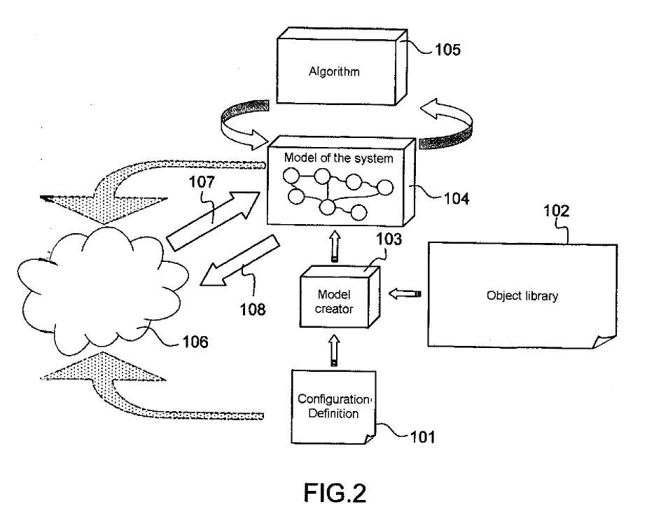

FIG. 2 represents an exemplary architecture of the maintenance system according to the invention. Said system is intended for the maintenance of a set of equipment items of an aircraft, forming the physical and logical networks 106 configured by configuration files 101. The maintenance system according to the invention is noteworthy in that it comprises:
an object library 102 generically representing each type of equipment of the physical network and the elements of the logical network 106,
means 103 for creating a model M from configuration files and from the object library. The means 103 for creating the model M create, for each equipment item of the physical network and elements of the logical network described in the configuration files, an object.
a model M 104 of the physical and logical networks comprising the operating status of the equipment items of the physical network, a representation of the elements of the logical network, and also the data obtained from dependability analysis,
means 107 for signaling modifications of the physical network (the loading of new equipment items into the network, network equipment failures, reconfiguration of the logical network or selective passivation) to the model M in real time,
means 108 for interrogating the physical network regarding the status of said equipment items and updating in real time the model M, an object being able, for example, to interrogate the equipment item with which it is associated to ascertain its status,
diagnostic means 105 using the model M to determine which equipment is faulty.

The present invention is based on the modelling of the set of equipment which makes it possible to use generic algorithmic principles which depend neither on the set of equipment concerned, nor on the implementation of the model.

The model 104 is supported by an architecture constructed on an object programming basis in which each of the objects represents an equipment item of the physical network (switch, link, port, connector, etc.) or an element of the logical network. The objects offer an interface dedicated to each of the generic diagnostic algorithms (fault tracing, fault/alarm correlation). A diagnostic algorithm can therefore be addressed uniformly to all the objects representing an equipment item. Each of the objects of the model reacts to the demands of the algorithm in a way that is specific to it. There is no limitation regarding this specific behavior. An object, when it receives a demand and it does not have the necessary information, can, for example, interrogate the equipment item with which it is associated. It is also possible to attach to the object a strategy for locally eliminating doubt (by interrogating several equipment items and asking for confirmation tests to be run, and so on).

Each object created in this way must perform a certain number of actions or requests necessary to the generic diagnostic algorithms. The latter define the interface between the objects of the model and the maintenance system. This interface is also generic. The manner in which this interface is implemented within each object is specific to the set of equipment items concerned, either simply determined in the model or based on data interchanges between actual equipment items and the model. Such a model makes it possible to process multiple and/or simultaneous failures. The model 104 and the generic algorithms are either hosted on an actual equipment item of the set concerned or are not part of the set of equipment items.

A model M 104 associated with the exemplary physical network comprises a set of objects representing the set of the equipment items, including the switches, their connectors and the links. The model M also comprises a representation of the logical network of the data flows called virtual links. A virtual link is characterized by the sending-mode connector of the equipment item sending data, by the receiving-mode connectors of the equipment receiving data and by the paths used to transmit the data. A path corresponds to an ordered set of links used by the data to travel from the sending-mode connector to a receiving-mode connector. A sending-mode connector can potentially be the sender of several virtual links. The concept of virtual link is sufficiently generic to be able to be applied to all types of links: discrete, ARINC 429, multiplexed, wireless, etc. For example, in the case of an ARINC 429 physical link, the path is identical to the virtual link which is in turn identical to the link.

It will be readily seen by one of ordinary skill in the art that the present invention fulfills all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A maintenance system for a set of equipment of an aircraft, forming a physical network and a logical network configured by configuration files, each item of said equipment being associated with a status indicating whether said equipment is malfunctioning and with data deriving from dependability analyses, each item of said equipment comprising at least one sending-mode connector or one receiving-mode connector, said maintenance system being also comprising:
a library of objects representing the equipment of the physical network and the elements of the logical network,
means for creating a model M from configuration files and from the object library,
a model M of the physical and logical networks, comprising the operating state of the equipment of the physical network, of the elements of the logical network and also the data obtained from dependability analyses,
means for signaling modifications of the physical network to the model M in real time,
means for interrogating the physical network regarding the state of said equipment and updating the model M in real time,
diagnostic means using the model M to determine which equipment is malfunctioning.

2. The maintenance system as claimed in claim 1, wherein the modifications of the physical network comprise: the loading of new equipment into the network, network equipment failures, reconfiguration of the logical network and selective passivation, that is, no longer using a part of the equipment network.

3. The maintenance system as claimed in claim 1, wherein the model M comprises objects representing the equipment, the links and the connectors of the equipment of the physical network and the interactions between equipment.

4. The maintenance system as claimed in claim 1, wherein the model M also comprises a representation of the logical network, called virtual link, of the data interchanges between a sending item of equipment and receiving equipment, said virtual links being defined by the sending-mode connector of the equipment sending data, by the receiving-mode connectors of the equipment receiving data and by the ordered set of the links used by the data to travel from the sending-mode connector to a receiving-mode connector.

5. The maintenance system as claimed in claim 1, wherein the objects of the model M include a failure probability established from data obtained from dependability analysis.

6. The maintenance system as claimed in claim 1, wherein the generic diagnostic means comprise a fault tracing algorithm determining the or each item of equipment most probably failing from the correlation of the fault states of the equipment and the equipment failure probabilities.

7. The maintenance system as claimed in claim 1, wherein the generic diagnostic means also comprise the identification of the equipment that cannot be accessed: connected to one or more equipment items that are malfunctioning or that have a defective sending-mode connector.

8. The maintenance system as claimed in claim 6, when an alarm signals a malfunction, the generic diagnostic means establish a relationship between said malfunction and a fault located by the fault tracing algorithm.

9. The maintenance system as claimed in claim 1, wherein the generic diagnostic means also comprise the filtering of the equipment currently being reinitialized or switched off.
